(19) United States
(12) Patent Application Publication
(10) Pub. No.: US 2025/0239912 A1
(43) Pub. Date: Jul. 24, 2025

(54) METHODS AND DEVICES FOR INTEGRATING GENERATORS IN AN ENGINE

(71) Applicant: Enginuity Power Systems, Inc., Alexandria, VA (US)

(72) Inventor: James C. Warren, Alexandria, VA (US)

(73) Assignee: Enginuity Power Systems, Inc., Alexandria, VA (US)

(21) Appl. No.: 19/026,987

(22) Filed: Jan. 17, 2025

Related U.S. Application Data
(60) Provisional application No. 63/622,761, filed on Jan. 19, 2024.

(51) Int. Cl. H02K 7/18; F02B 63/04; F16C 3/10; H02K 7/075

(52) U.S. Cl. CPC H02K 7/1815; F02B 63/042; H02K 7/075; F16C 3/10

(57) ABSTRACT

Electrical generators may be configured and positioned at interior points and positions along the length of an engine's crankshaft or crank case to provide electrical energy.

### RELATED APPLICATIONS

This application claims priority to U.S. Patent Application 63/622,761 filed on Jan. 19, 2024 (the '761 Application). This application is also related to U.S. patent application Ser. No. 18/141,378 (the '378 Application). This application incorporates by reference the entire disclosures of the '761 and '378 Applications as if both disclosures were set forth in full herein.

### INTRODUCTION

This section introduces aspects that may be helpful to facilitate a better understanding of the described disclosure. Accordingly, the statements in this section are to be read in this light and are not to be understood as admissions about what is, or what is not, in the prior art.

It is desirable to provide methods and devices for generating electrical energy using one or more electrical generators that are positioned along interior points and positions of an engine's crankshaft that overcome shortfalls of existing designs and techniques without adding weights to a crankshaft to maintain a correct engine balance and minimize vibrations.

It is further desirable to provide methods and devices for generating electrical energy using one or more electrical generators that are positioned along interior points and positions of an engine's crankshaft and where the overall engine fits within a smaller volume.

### SUMMARY

The inventors disclose various methods and devices for integrating generators into interior points and positions of a piston driven engine.

### DESCRIPTION OF THE DRAWINGS

FIG. 1 depicts a simplified, exemplary representation of a plurality of inventive, electrical generators positioned along the interior points and positions of a crankshaft of an engine (“integrated generator”) according to an example of the present disclosure.

FIG. 2 depicts a simplified representation of components of an inventive, integrated generator according to one embodiment of the present disclosure.

FIG. 3 depicts an external view of an inventive, integrated generator according to one embodiment of the present disclosure.

FIGS. 4A to 4D depict views of a second, simplified exemplary representation of a plurality of integrated generators according to an example of the present disclosure.

FIG. 4E depicts yet another illustration of an engine that includes a plurality of integrated generators.

FIGS. 4F to 4H depict an enlarged views of integrated generators according to examples of the present disclosure.

FIG. 4I depicts an external view of an inventive engine that includes a plurality of inventive generators positioned at different interior points or positions along the length of the engine's rotatable crankshaft according to an embodiment of the present disclosure.

FIGS. 5A and 5B depict views of another integrated generator according to another example of the present disclosure.

FIG. 5C depicts an exterior view of a rotor according to an example of the present disclosure.

FIG. 6 depicts a view of a crankshaft that comprises a plurality of discs or rotors having a magnetic coating according to an example of the present disclosure.

FIGS. 7A and 7B depict illustration of an exemplary engine that includes one or more integrated generators according to an example of the present disclosure.

### DETAILED DESCRIPTION, WITH EXAMPLES

Exemplary embodiments of methods and devices for integrating generators along the points and positions of an engine's internal aspects of the crankshaft are described herein and are shown by way of example in the drawings. Throughout the following description and drawings, like reference numbers/characters refer to like elements.

It should be understood that although specific embodiments are discussed herein, the scope of the disclosure is not limited to such embodiments. On the contrary, it should be understood that the embodiments discussed herein are for illustrative purposes, and that modified and alternative embodiments regarding the specific methodologies used to generate power from a rotor and a stator including, but not limited to, induction generators, synchronous generators and mutual induction generators that otherwise fall within the scope of the disclosure are contemplated.

It should also be noted that one or more exemplary embodiments may be described as a process or method (the words “method” or “methodology” may be used interchangeably with the word “process” herein). Although a process/method may be described as sequential, it should be understood that such a process/method may be performed in parallel, concurrently or simultaneously. In addition, the order of each step within a process/method may be re-arranged. A process/method may be terminated when completed, and may also include additional steps not included in a description of the process/method if, for example, such steps are known by those skilled in the art.

As used herein, the term “and/or” includes any and all combinations of one or more of the associated listed items. As used herein, the singular forms “a,” “an” and “the” are intended to include the plural form, unless the context and/or common sense indicates otherwise.

It should be understood that when a device, or a component or element is referred to, or shown in a figure, as being “connected” to (or other tenses of connected) another device (or component or element) such devices, components or elements may be directly connected, or may use intervening components or elements to aid a connection. In the latter case, if the intervening devices, components or elements are well known to those in the art they may not be described herein or shown in the accompanying figures for the sake of clarity.

As used herein the terms “operable to” or “operate” means “functions to” unless the context, common sense or knowledge of one skilled in the art indicates otherwise.

As used herein, the term “embodiment” or “exemplary” mean an example that falls within the scope of the present disclosure.

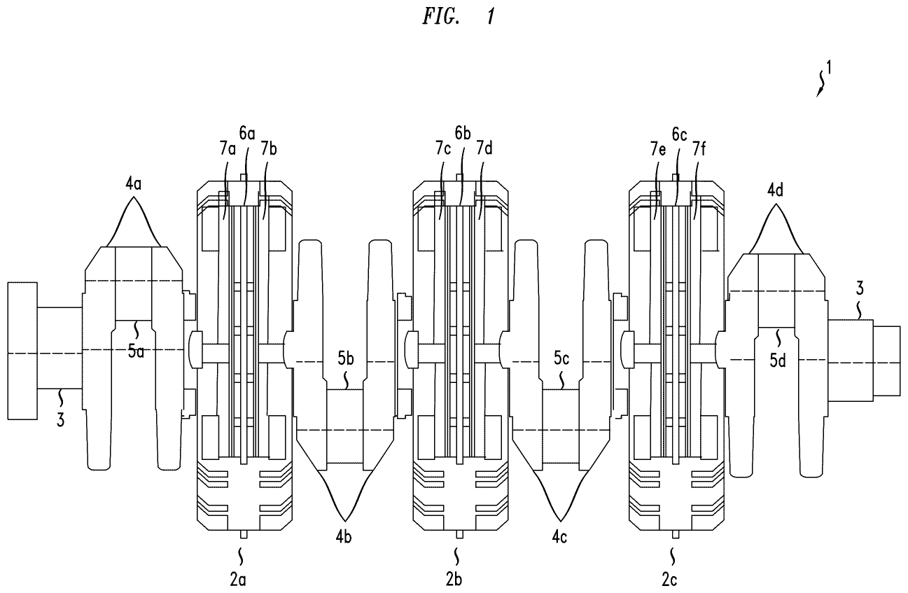

Referring to FIG. 1 there is depicted a simplified, exemplary representation of a plurality of inventive generators 2a to 2c integrated at interior points and positions along the length of a crankshaft 3 of an engine 1 (e.g., a four stroke, opposed piston engine, abbreviated “OPE” that may be fueled by hydrogen, gasoline, diesel, natural gas) according to an example of the present disclosure. It should be understood, however, that the configuration of the generators described herein is not limited to OPEs. Rather, the configuration of generators disclosed herein along the length of a crankshaft or crank case may be applied to many engines other than OPEs that use a crankshaft and a crankcase. The engine 1 (and each of the engines disclosed herein) may be configured as so-called “horizontal” or “vertical” engines.

For the sake of clarity, when used herein the phrases “along the length of a crankshaft” or “crank case” means at least one generator that is positioned at an interior point or position along a crankshaft or crank case. When more than one generator is so positioned, each generator may be configured and positioned at a different point or position.

While only one crankshaft 3 and three integrated generators 2a to 2c are shown it should be understood that the present disclosure can be applied to an engine with multiple crankshafts and/or multiple cylinders and more or less generators depending on the requirements of a given application.

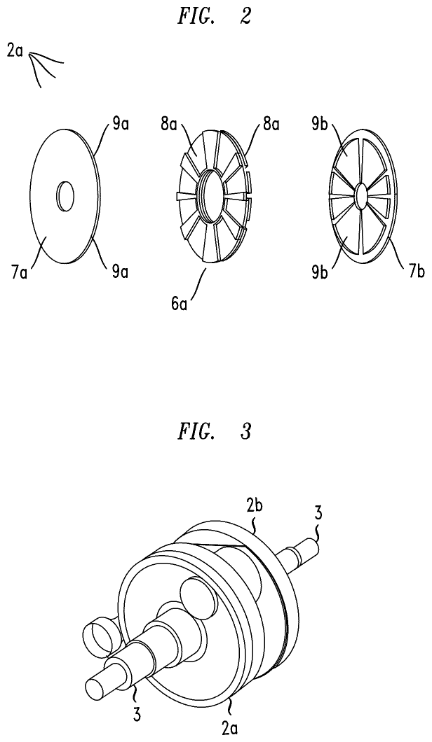

In an embodiment, the engine 1, including, but not limited to the inventive integrated generators 2a to 2c may be configured to fit within a small volume, which may reduce the footprint (volume) of existing generators by as much as 40-50% while maintaining the same displacement and power. In one embodiment, an engine 1 (and others disclosed herein in FIGS. 2 to 7B) that includes the inventive generators 2a to 2c may generate and output 35 to 40 kilowatts of power, for example, it being understood that this power range is only one, non-limiting example of a power range.

As shown, a first movable piston structure 4a may be coaxially fixed to, and about, a crankshaft 3. It should be understood that the first structure 4a may comprise a first connecting rod 5a which in turn is connected to a first piston. For ease of understanding the first piston (and all pistons) of the engine 1 are not shown, Further, only the connecting structure of the first piston arm 5a is shown.

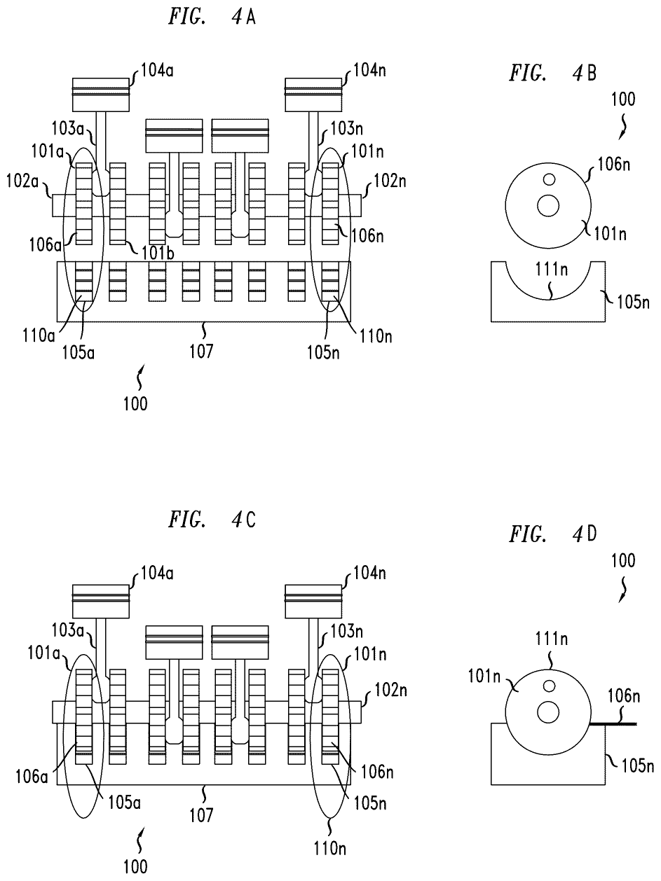

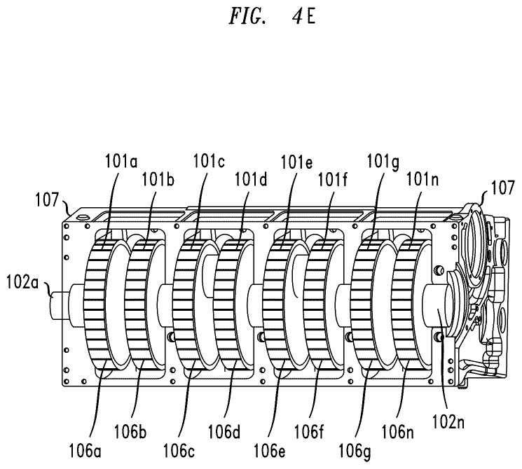

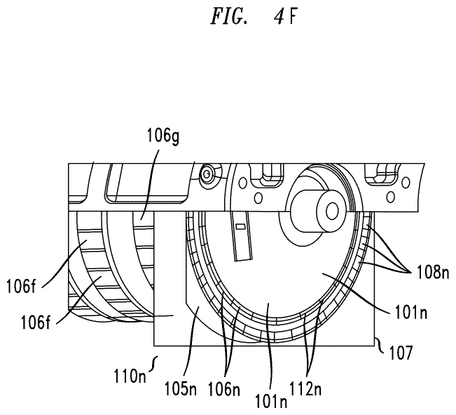

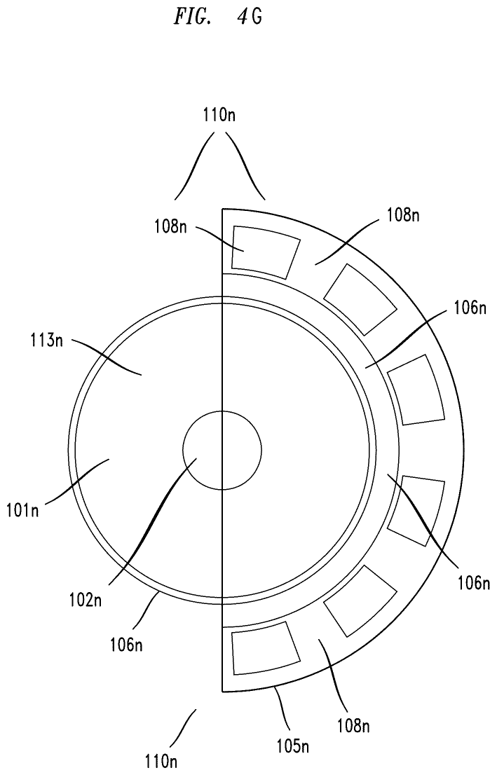

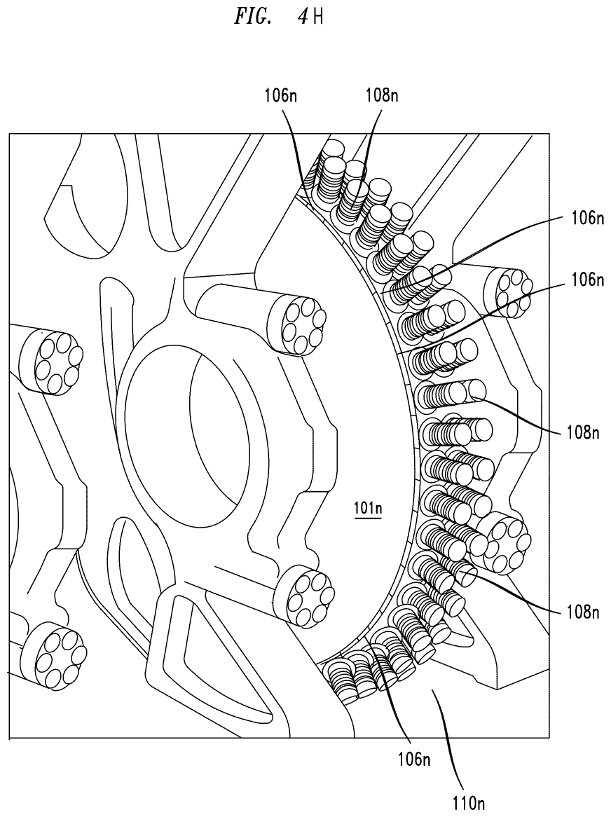

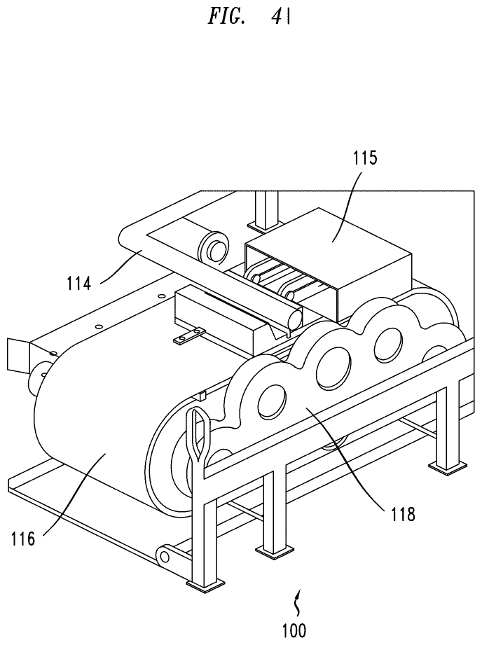

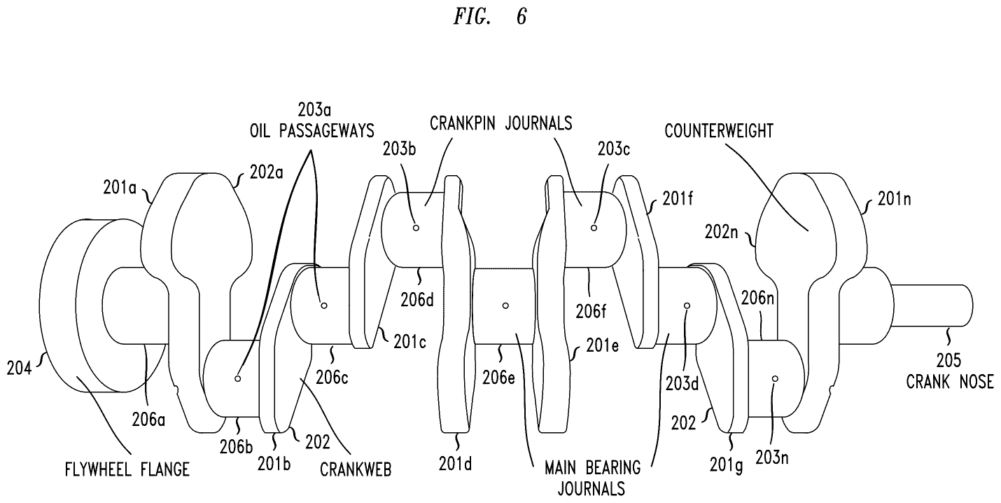

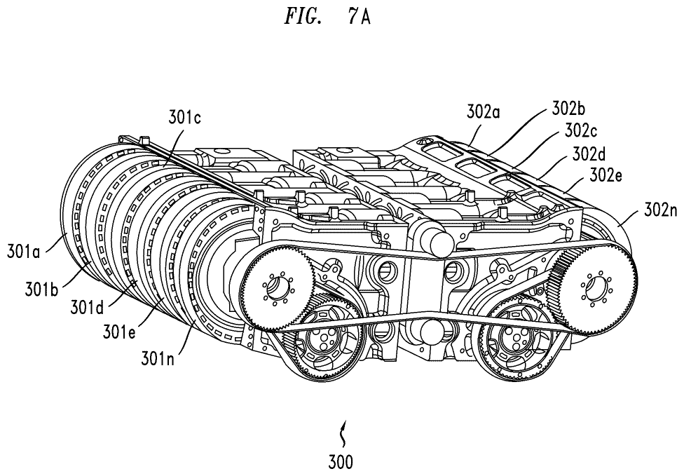

The engine 1 may comprise one or more cylinders and similar movable piston structures 4a to 4d at interior points and positions along the length of the crankshaft 3, where each structure 4a to 4d may be coaxially fixed to, and about, a different interior point or position along the length of the rotatable crankshaft 3 and each structure 4a to 4d may comprise a respective piston arm 5a to 5d connected to a respective piston (again, pistons are not shown). The engine 1, and in particular generators 2a to 2c may be cooled by a number of alternative techniques, including, but not limited to oil sprayed into the interior of generators 2a to 2c (spray inlets not shown in figures) or through passageways or grooves (see FIG. 4F, element 112n and FIG. 6 elements 203a to 203n, for example).

Accordingly, as the piston structures 4a to 4d and connected crankshaft 3 move due to the forces of combustion or compression generated within the engine 1 (or via other means of generating energy, e.g., electrical batteries) the movable energy of the structures 4a to 4d may be converted into electrical energy by the integrated generators 2a to 2c.

The reader may note that each generator 2a to 2c may be located at a position where normally there may be a crank weight of some kind. Thus, instead of a crank weight the inventor has discovered how to integrate generators onto a crank shaft without the need to add additional crank weights or bob weights. Said another way, the inventor has substituted generators for crank weights.

In more detail, we now focus on exemplary, integrated generator 2a, it being understood that integrated generators 2b and 2c may be constructed and operate similarly, where each of the generators 2a to 2c are configured at different interior points or positions along the length of the crankshaft 3.

Integrated generator 2a may be configured at an interior point or position along the length of the crankshaft 3 and may comprise a substantially stationary structure or stator 6a and one or more rotatable structures or rotors 7a, 7b that may be attached to the rotatable crankshaft 3. The rotors 7a, 7b, for example, may be circular in shape and may be configured in a parallel, geometric plane as the stator 6a. In an embodiment of the present disclosure the exemplary stator 6a may be circular in shape and may comprise coils of insulated wire configured around a laminated core (collectively “windings” 8a; see FIG. 2) while each of the rotors 7a, 7b may comprise one or more respective electromagnets 9a, 9b (see FIG. 2), respectively, which may be composed of one or more known materials and configurations attached to rotors 7a, 7b via one or more known methods of attachment and may be configured on a surface of the rotor 7a, 7b in a circular orientation that faces a surface of the stator 6a (e.g., one surface of the stator 6a faces electromagnets 9a on the surface of rotor 7a, while the opposite surface of the stator 6a faces the electromagnets 9b on the surface of rotor 7b).

While in this embodiment the electromagnets of the rotor are positioned on a lengthwise surface of the rotor in other embodiments the electromagnets may be positioned on and around a circumferential end or rim of a rotor for example (see FIGS. 4A to 4E and rotors 101a to 101n for example). Still further, in an alternative embodiment, the electromagnets 9a,9b may be replaced with electrical windings made of known conductive material. Further, electromagnets or windings may be shaped and configured along or around the respective rotors 7a, 7b so as to insure desirable electrical characteristics, reliable operation and durability. In either or each configuration the electromagnets of the rotor must be sufficiently adjacent to the stator to produce an electromagnetic effect and resulting electrical current.

Accordingly, as the crankshaft 3 rotates, so too do the circular rotors 7a, 7b of generator 2a positioned at an interior point or position along the length of the crankshaft 3 and their respective electromagnets 9a, 9b on surface of the rotors 7a, 7b. In an embodiment, the rotation of the electromagnets 9a, 9b generates an electrical current in the windings 8a of the substantially circular and stationary stator 6a due electromagnetic forces generated between the rotating rotors 7a,7b and stationary stator 6a. Still further, the rotation of the electromagnets within each of the generators 2a to 2c positioned at an interior point or position along the length of the crankshaft 3 generates electrical currents in each of the windings of each of the substantially stationary stators with each generator 2a to 2c due to electromagnetic forces generated between the respective rotating rotors and respective stationary stator.

The electrical current(s) generated within the windings of each of the generators 2a to 2c may be output individually or combined via electrical connectors and conductors (not shown for clarity) and then output to power one or more electrical or electronic devices, for example.

Referring again to FIG. 2, there is depicted a simplified representation of exemplary components of the exemplary inventive, integrated generator 2a that may be positioned at an interior point or position along the length of the engine's 1 crankshaft 3 according to one embodiment of the present disclosure, it being understood that integrated generators 2b and 2c may be positioned, constructed and operate similarly.

As shown, an exemplary generator may comprise rotors 7a,7b which may be configured as circular plates and composed of one or more known materials and a circular stator 6a which may also be composed of known materials, for example, and may be configured to be “sandwiched” between rotors 7a, 7b, for example. Though in this embodiment the windings 8a of the stator 6a may encompass, cover or be adjacent to 100% of the electromagnets 9a or 9b of a respective rotor 7a, 7b this is merely exemplary. In other embodiments disclosed herein the windings of a stator may be configured to encompass, cover or be adjacent to less than 100% of the electromagnets of a respective rotor. Said another way, the windings (or magnets) of an exemplary stator disclosed herein may encompass, cover or be adjacent to a percentage of the electromagnets of a respective rotor between a minimal percentage that results in an effective energy output up until 100% of the electromagnets. In one embodiment an exemplary minimal percentage of electromagnets covered by a stator is equal to 50% of the electromagnets of a rotor. In yet another embodiment the minimal percentage is between 25% and 100% of the electromagnets of a rotor.

In an embodiment, windings 8a of the stator 6a may be at least configured around both surfaces of the stator 6a that face respective rotors 7a, 7b. For example, windings 8a on one surface of the stator 6a may face magnets 9a on the inwardly facing surface of rotor 7a while windings 8a on the opposite surface of the stator 6a may face the magnets 9b on the inwardly facing surface of rotor 7b, for example. The outwardly facing surfaces of rotors 7a,7b may operate as coverings or plates.

FIG. 3 depicts an external view of inventive generators 2a,2b positioned at different interior points or positions along the length of an engine's rotatable crankshaft 3 according to one embodiment of the present disclosure.

Referring now to FIGS. 4A and 4B there are depicted views of a second, simplified exemplary representation of a plurality of integrated generators 110a to 110n (where “n” indicates a last integrated generator) according to an example of the present disclosure. As will be disclosed in more detail herein, each integrated generator 110a to 110n comprises at least one movable rotor 101a to 101n and at least one stationary stator 105a to 105n.

In this embodiment the windings or magnets of each stator 105a to 105n may encompass, cover or be adjacent to 50% or more of the electromagnets 106a to 106n of a respective rotor 101a to 101n.

Each integrated generator 110a to 110n may be positioned along the length of a crank case 107 of an engine 100 (e.g., OPE that may be fueled by hydrogen, gasoline, diesel, natural gas or use batteries) according to an example of the present disclosure. While only eight integrated generators 110a to 110n are shown it should be understood that the present disclosure can be applied to more or less generators depending on the requirements of a given application. As noted previously, for the sake of clarity, when used herein the phrases “along the length of a crank case” or “crank shaft” means at least one generator that is located at an interior point or position along the length of a crankshaft or crank case. When more than one generator is so positioned, each generator may be configured and positioned at a different point or position along a referential geometric axis.

Further, the disclosed configuration of generators 110a to 110n is not limited to OPEs. Rather, the configuration of generators disclosed herein along the length of a crankshaft or crank case may be applied to many other engines other than OPEs that use a crankshaft/crank case.

In an embodiment, the engine 100, including, but not limited to the inventive integrated generators 110a to 110n may be configured to fit within a small volume, such as a volume equal to, or less than, a volume of no more than 12.5 inches in height, 24 inches in width and 32 to 50 inches in length, for example, which may reduce the footprint (volume) of existing generators by as much as 40-50% while maintaining the same displacement and power. In one embodiment, the engine 100 that includes the inventive generators 110a to 110n may generate and output 35 to 40 kilowatts of power (e.g., 38 kilowatts), for example.

As shown, a first piston 104a may be coaxially fixed to, and about, a movable crankshaft section 102a by a piston arm 103a. Similarly, additional pistons 104b to 104n may be respectively, individually coaxially fixed to, and about, movable crankshaft sections 102b to 102n by individual piston arms 103b to 103n, where each piston 104a to 104n and their respective crankshaft sections 102a to 102n and piston arms 103a to 103n may be positioned at a different interior point or position along the length of a crank case 107.

Collectively, each piston 104a to 104n and each 103a to 103n may be referred to as a piston structure. Each piston structure is connected to at least one movable section (i.e., “rotor” for short) 101a to 101n of each of the integrated generators 110a to 110n, where, again, in an embodiment each integrated generator 110a to 110n may comprise at least one rotor 101a to 101n.

FIGS. 4A and 4B depict the integrated generators 110 to 110n before a portion or percentage of each rotor 101a to 101n is inserted into the engine crank case 107 to be encompassed, covered or adjacent to a respective stator 105a to 105n while FIGS. 4C and 4D depict the integrated generators 101a to 101n after a portion of each rotor 101a to 101n is inserted into the engine crank case 107 and is encompassed, covered or adjacent to a respective stator 105a to 105n in order to illustrate the fact that once inserted into the crank case 107, only approximately one half of each rotor 101a to 101n (i.e., a “portion” or “percentage”) is inserted into the crank case 107 during a time period while the other approximately one half of each rotor 101a to 101n is not inserted during the same time period and remains outside the crank case 107.

In embodiments, the portion of each rotor 101a to 101n that is inserted in the crank case 107 may be cooled by a number of alternative techniques, including, but not limited to, a combination of oil sprayed onto the embedded rotor portions (spray inlets not shown in figures) and/or passageways while the portion of each rotor 101a to 101n that is not inserted in the crank case 107 may be cooled by a number of alternative techniques, including, but not limited to, fans or passageways or some combination of such colling methods.

FIGS. 4A to 4D also illustrate electromagnets or an electromagnetic material 106a to 106n on the surface of each rotor 101a to 101n. In embodiments, the electromagnets may be configured as strips of magnetic material composed of one or more known materials positioned on and around the circumferential end or rim of each rotor 101a to 101n.

Further, each piece of electromagnetic material 106a to 106n may be separated from another piece of electromagnetic material 106a to 106n by a piece of known non-electromagnetic material (see FIG. 6 and elements 154n).

As noted above, each generator comprises at least one rotor 101a to 101n and at least one stationary section (i.e., a “stator”) 105a to 105n. It should be understood that each respective rotor 101a to 101n may be configured in a parallel, geometric plane as a respective stator 105a to 105n, for example.

In embodiments, each stator 105a to 105n may comprise a surface 111a to 111n (see FIGS. 4B and 4D that show only one of the surfaces 111n) that may be configured and shaped to receive the inserted portion of a respective rotor 101ato 101n. Though inserted, each inserted portion of a rotor 101a to 101n does not touch a respective surface 111a to 111n (i.e., there is a gap in between an inserted rotor portion and the surface). Along each surface 111a to 111n there may be positioned stationary magnets (see FIGS. 4B and 4D) that are a part of each integrated generator 110a to 110n.

FIG. 4E depicts yet another illustration of the engine 100 with a focus on the portions of each rotor 101a to 101n (e.g., its electromagnets) that are inserted into the engine crank case 107 such that they are encompassed, covered or adjacent to a respective stator (stator not shown) in order to once again illustrate the fact that once inserted into the crank case 107, only approximately one half of each rotor 101a to 101n and its electromagnets is inserted into the crank case 107 during a time period while the other approximately one half of each rotor 101a to 101n is not inserted during the same time period and remains outside the crank case 107.

Referring now to FIG. 4F there is shown a close up view of a generator 110n. For the reader's guidance, the left side of FIG. 4F is a cut-a-way view of the generator 110n with its stator and windings removed (as an illustration) to enable the reader to see the electromagnets 106f and 106g of a rotors 101f, 101g underneath the stator windings while the right side of FIG. 4F includes the stator 105n and its windings 108n within crank case or endcap 107. FIG. 4F also illustrates passageways 112n for holding oil which allows the oil to be distributed to the electromagnets 106n in order to cool portions of the rotor 101n.

FIG. 4G depicts an enlarged view of a single integrated generator 110n according to an example of the present disclosure. As shown the stator 105n comprises one or more (i.e., a plurality) of electrical windings 108n, it again being understood that each stator 105a to 105n comprises such respective windings. As noted elsewhere, in an embodiment of the present disclosure the exemplary windings 108n may comprise coils of insulated wire configured around a laminated core. FIG. 4G also depicts: (i) the position of an exemplary piston arm pin 113n that may be connected to, or a part of, the piston arm 103n (see FIGS. 4A and 4C) that connects the piston arm 103n to the rotor 101n which comprises, and may function as, a circular crank weight; crankshaft section 102n; and electromagnets 106n. In this embodiment the stator 105n (i.e., its windings 108n) encompasses, covers or is adjacent to 50% of the electromagnets 106n of a respective rotor 101n.

Referring now to FIG. 4H there is yet another view of generator 110n. In this view both the rotor 101n and its electromagnets 106n (squares underneath each winding 108n) and the windings 108n of the stator 105n are shown though the endcap or crank case upon which the stator and its windings reside and that covers the windings 108n and stator 105n has been removed.

Though not shown in the figures, it should be understood that control electronics for controlling the output of the integrated generators described herein may also be included in the exemplary engines described herein. In an embodiment, such control electronics may be positioned inside an engine crankcase endcap, for example though this is just one of many positions where the control electronics can be located.

It should be understood that while a figure may illustrate only one exemplary, integrated generator (e.g., generator 110n) that integrated generators 110a to 110n may be constructed and operate similarly, where each of the generators 110a to 110n may be configured at different interior points or positions along the length of the crank shaft section or crank case 107 (i.e., along a common geometric axis).

Referring now to FIG. 4I there is depicted an external view of the inventive engine 100 that includes plurality of inventive generators 110a to 110n positioned at different interior points or positions along the length of the engine's crank case according to an embodiment of the present disclosure. Also shown are an exhaust manifold 114, intake plenum 115, stator cover or endcap 116 and gear synchronization cover 118.

Combining FIGS. 4E through 4H with FIGS. 4A and 4C, as the pistons 104a to 104n move due to the forces of combustion or compression generated within the engine 100 (or via other means of generating energy, e.g., electrical batteries), the energy of the pistons 104a to 104n forces the crankshaft sections 102a to 102n to move which, in turn causes the rotors 101a, 101n of each generator 110a to 110n positioned at different interior points or positions along the length of the crank case 107 and their respective one or more electromagnets or electromagnetic strips 106a to 106n to move. In an embodiment, the rotation of the electromagnets or electromagnetic strips 106a to 106n that are partially inserted in the stator 105a to 105n (i.e., the portions) generates an electrical current in the windings 108a to 108n of each substantially stationary stator 105a to 105n due to electromagnetic forces generated between the inserted portions of the movable rotors 101a to 101n and stationary windings 108a to 108n. The electrical current(s) generated within the windings 108a to 108n of each of the generators 110a to 110n may be output individually or combined via electrical connectors and conductors (not shown for clarity) and then output to power one or more electrical or electronic devices, for example.

In an embodiment, the engine 100 that includes the inventive generators 110a to 110n may generate and output 35 to 40 kilowatts of power,

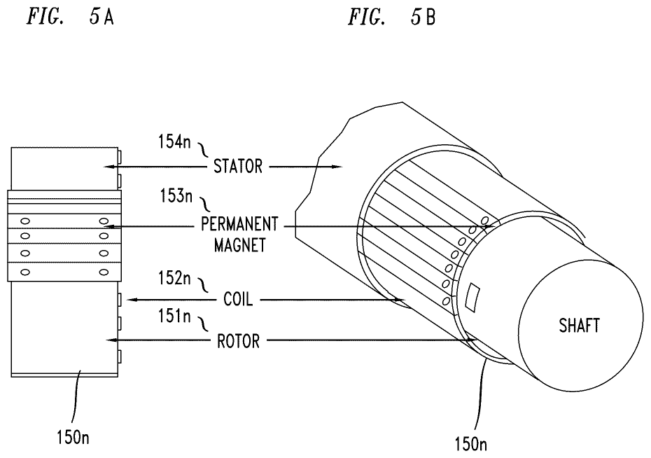

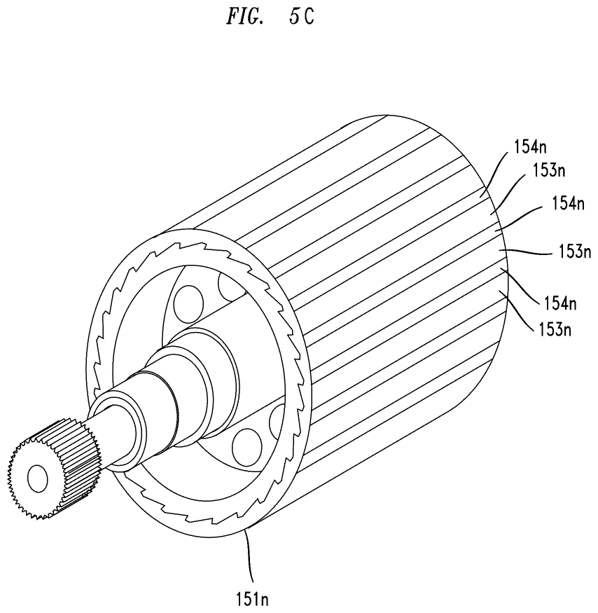

Referring now to FIGS. 5A and 5B there is depicted views of another exemplary integrated generator 150n according to an example of the present disclosure.

As shown the generator 150n comprises at least one stator 154n, where the stator 154n may comprise one or more (i.e., a plurality) of electrical windings 152n. In an embodiment of the present disclosure the exemplary windings or coils 152n may comprise coils of insulated wire configured around a laminated core. Also shown is a rotor 151n with its electromagnets or electromagnetics strips 153n.

Referring now to FIG. 5C there is depicted one example of the exemplary rotor 151n. As shown, one manifestation of the rotor 151n may be comprised of electromagnets or electromagnetic material (e.g., strips) 153n on the surface of the rotor 151n. In embodiments, the strips may be configured on the perimeter surface of the rotor 151n. Further, each strip of electromagnetic material 153n may be separated from another piece of electromagnetic material 153n by a piece of non-electromagnetic material 154n.

Referring to FIG. 6 there is depicted a crankshaft 200 that comprises a plurality of discs 201a to 201n, where each disc 201a to 201n may comprise a plurality of magnets or magnetic coating 202a to 202n on its surfaces according to an example of the present disclosure. In embodiments, discs 201a and 201n may function as both crank shaft counterweights and as rotors (stators not shown for clarity). Thus, by using the weight of the rotor itself no additional counterweights are needed to correctly balance an inventive engine that contains the rotors 201a to 201n. In an embodiment, each cylinder of a respective, inventive engine may include two rotatable discs from among 201b to 201g.

Also shown are oil passageways 203a to 203n which can be used to hold and distribute oil to cool the portions of the rotors which are internal to the crankcase (not shown) inserted into a stator (also not shown), a flywheel flange 204, a crank nose 205 and crank sections 206a to 206n (e.g., crankpin and main bearing journals).

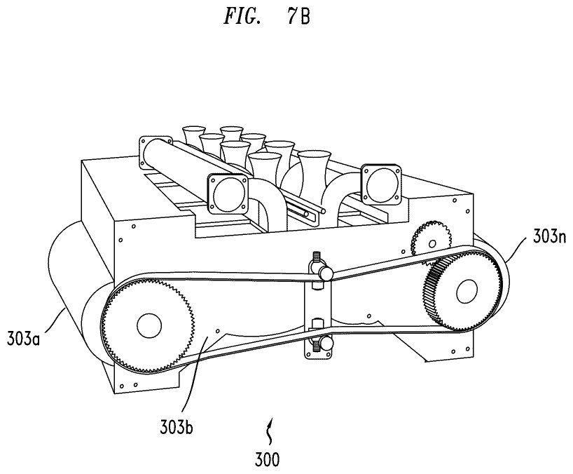

Referring now to FIGS. 7A and 7B there are depicted views of an engine 300 according to an embodiment of the disclosure. The engine 300 may comprise an inwardly opposed piston engine comprising a plurality of integrated generators. In FIG. 7A only the portions of each rotor 301a to 301n and 302a to 302n that are inserted into the engine crank case which includes stators are shown, where portions of rotors 301a to 301n are associated with one set of inwardly opposed pistons and the other portions of rotors 302a to 302n are associated with another set of inwardly opposed pistons. In FIG. 7B there are depicted sections of an external cases or covers 303a to 303n, where the cases or covers 303a to 303n that enclose the stators and rotors may be shaped to match the shape (e.g., curve) of a rotor or stator. In FIGS. 7A and 7B the windings or magnets of exemplary stators (not shown) disclosed herein may encompass, cover or be adjacent to a percentage of the electromagnets of a respective rotor between a minimal percentage that results in an effective energy output up until 100% of the electromagnets. In one embodiment an exemplary minimal percentage is equal to 50% of the electromagnets of a rotor 302a to 302n.

The reader may note that the inventive rotors disclosed herein may be circular in shape or may be of another shape (see rotors 201a to 201n in FIG. 6). In either case, by using the weight of the rotor itself no additional counterweights are needed to correctly balance the inventive engines.

As noted initially this disclosure may be related to the '378 Application. In an embodiment, certain features of the disclosure of the '378 Application may be combined with features of the instant application (hereafter “combination engine”). For example, an inventive combination engine may comprise an inwardly opposed piston engine configured as a L-head or “flat-head” engine that includes (i) a plurality of electrical generators integrated along a crankshaft at different interior points or positions along the length of the crankshaft (ii) a first and a second engine block, the first engine block comprising one or more first cylinders and the second engine block comprising one or more second cylinders, where each first cylinder may comprise a first piston and each second cylinder may comprise a second piston, (iii) one or more bolts (e.g., spar bolts) configured to mate the first engine block to the second engine block such that each first cylinder and its respective piston is inwardly, opposedly aligned with one of the second cylinders and its respective piston, and (iv) one or more aluminum spacers configured between the first and second engine blocks, each spacer comprising one or more openings or perforations to allow the one or more bolts to pass through unimpeded, wherein the one or more bolts pass through approximately an entire length comprising the first engine block, the one or more aluminum spacers, and the second engine block.

In yet further embodiments each of the one or more bolts of the combination engine may be configured to longitudinally pass through openings in the first engine block and the second engine block and through one or more openings or perforations in each of the one or more spacers.

It should be understood that the inventive devices and methods described herein are only some of the many embodiments that fall within the scope of the disclosure and claims that follow, it being impractical to discuss all possible embodiments.

I claim:

1. An engine comprising one or more electrical generators, each generator configured and positioned at a different interior point or position along the length of a crankshaft or a crank case to provide electrical energy and each generator comprising,
a rotor and a stator, wherein the rotor comprises electromagnets positioned on and around the circumferential end or rim of each rotor and the stator comprises windings or magnets that are adjacent to 50% or more of the electromagnets of the rotor.

2. The engine of claim 1 wherein the engine comprises an inwardly opposed piston engine.

3. The engine of claim 1 wherein the electromagnets comprise strips of magnetic material.

4. The engine as in claim 1 wherein the engine comprises an inwardly opposed piston engine configured as an L-head or “flat-head” engine, wherein the engine further comprises (i) a first and a second engine block, the first engine block comprising one or more first cylinders and the second engine block comprising one or more second cylinders, where each first cylinder may comprise a first piston and each second cylinder may comprise a second piston, (ii) one or more bolts configured to mate the first engine block to the second engine block such that each first cylinder and its respective piston is inwardly, opposedly aligned with one of the second cylinders and its respective piston, and (iii) one or more spacers configured between the first and second engine blocks, each spacer comprising one or more openings or perforations to allow the one or more bolts to pass through unimpeded, wherein the one or more bolts pass through approximately an entire length comprising the first engine block, the one or more spacers, and the second engine block.

5. The engine as in claim 1 comprising a volume equal to, or less than, a volume of no more than 12.5 inches in height, 24 inches in width and 32 to 50 inches in length.

6. The engine as in claim 1 wherein the one or more electrical generators generate 35 to 40 kilowatts of power.

7. A method for generating electrical power comprising:
configuring and positioning one or more electrical generators at a different interior point or position along the length of a crankshaft or a crank case of an engine to provide electrical energy, where each generator comprises a rotor and a stator, and the method further comprises positioning electromagnets positioned on and around the circumferential end or rim of each rotor and positioning windings or magnets of the stator adjacent to 50% or more of the electromagnets of the rotor.

8. The method of claim 7 wherein the engine comprises an inwardly opposed piston engine.

9. The method of claim 7 wherein the electromagnets comprise strips of magnetic material.

10. The method of claim 7 wherein the engine comprises an inwardly opposed piston engine configured as an L-head or “flat-head” engine, wherein the method further comprises mating a first engine block to a second engine block using one or more bolts and configuring one or more spacers between the first and second engine blocks, where each spacer comprises one or more openings or perforations to allow the one or more bolts to pass through unimpeded, wherein the one or more bolts pass through approximately an entire length comprising the first engine block, the one or more spacers, and the second engine block.

11. The method as in claim 7 wherein the engine comprises a volume equal to, or less than, a volume of no more than 12.5 inches in height, 24 inches in width and 32 to 50 inches in length.

12. The method as in claim 7 further comprising generating 35 to 40 kilowatts of power.
